(19) United States
(12) Patent Application Publication
(10) Pub. No.: US 2025/0175843 A1
(43) Pub. Date: May 29, 2025

(54) SYSTEMS AND METHODS FOR DEVICE-TO-DEVICE COMMUNICATIONS

(71) Applicant: ZTE CORPORATION, Shenzhen (CN)

(72) Inventors: Weiqiang DU, Shenzhen (CN); Lin CHEN, Shenzhen (CN); Wei LUO, Shenzhen (CN)

(73) Assignee: ZTE CORPORATION, Shenzhen (CN)

(21) Appl. No.: 19/039,300

(22) Filed: Jan. 28, 2025

Related U.S. Application Data
(63) Continuation of application No. PCT/CN2022/144158, filed on Dec. 30, 2022.

(51) Int. Cl. H04W 24/10; H04L 5/00; H04W 92/18

(52) U.S. Cl. CPC H04W 24/10; H04L 5/0048; H04W 92/18

(57) ABSTRACT

The present disclosure relates to communicating, by a first wireless communication device with a second wireless communication device, via a sidelink interface. The first wireless communication device may send at least one of beam measurement configuration or beam Reference Signal (RS) to the second wireless communication device via the sidelink interface. The first wireless communication device may receive beam measurement result from the second wireless communication device via the sidelink interface.

### CROSS-REFERENCE TO RELATED APPLICATION

This application claims the benefit of priority under 35 U.S.C. § 120 as a continuation of PCT Patent Application No. PCT/CN2022/144158, filed on Dec. 30, 2022, the disclosure of which is incorporated herein by reference in its entirety.

### TECHNICAL FIELD

The disclosure relates generally to wireless communications and, more particularly, to device-to-device communications on Frequency Range 2 (FR2).

### BACKGROUND

Sidelink (SL) communication refers to wireless radio communication between two or more User Equipments (UEs). In this type of communications, two or more UEs that are geographically proximate to each other can communicate without being routed to a Network (e.g. Base Station (BS)) or a core network. Data transmissions in SL communications are thus different from typical cellular network communications that include transmitting data to a Network and receiving data from a Network. In SL communications, data is transmitted directly from a source UE to a target UE through, for example the Unified Air Interface (e.g., PC5 interface) without passing through a Network.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

Some arrangements of the present disclosure relate to systems, methods, apparatuses, and non-transitory computer-readable media relating to communicating, by a first wireless communication device with a second wireless communication device, via a sidelink interface. The first wireless communication device may send at least one of beam measurement configuration or beam Reference Signal (RS) to the second wireless communication device via the sidelink interface. The first wireless communication device may receive beam measurement result from the second wireless communication device via the sidelink interface.

In some arrangements, sending the beam measurement configuration may comprise starting a beam measurement procedure. The beam measurement procedure can be started in response to at least one of: a beam measurement timer expiry; determining that the first wireless communication device is to establish a unicast link; generating a Direct Communication Request (DCR) message; generating a sidelink Signaling Radio Bearer (SRB) message; or detecting a beam failure. The first wireless communication device may perform at least one of following in response to starting the beam measurement procedure: starting a beam measurement timer; starting a beam configuration transmission timer; or transmitting the beam measurement configuration. In response to determining that the beam configuration transmission timer has expired, the first wireless communication device may transmit the beam measurement configuration.

In some arrangements, the first wireless communication device may re-start the beam configuration transmission timer. In response to transmitting a first beam measurement configuration, the first wireless communication device may transmit a second beam measurement configuration. In response to determining that a number of beam measurement configuration transmission reaching a maximum number of beam measurement configuration transmission, performing at least one of following: the first wireless communication device may stop the beam measurement procedure, or the first wireless communication device may stop the beam measurement transmission timer.

In some arrangements, the beam measurement configuration may comprise at least one of: a beam configuration transmission timer; a beam measurement timer; maximum number of beam measurement configuration transmission; an indication indicating whether the beam RS is present; an indication indicating whether the second wireless communication device receiving the beam measurement configuration is to measure the beam RS; an indication indicating whether the second wireless communication device receiving the beam measurement configuration is to report the beam measurement result to the first wireless communication device; resource configuration for the beam RS; an identifier (ID) of the beam measurement configuration; an ID of the beam RS; a measurement request indicating whether the second wireless communication device is to report the beam measurement result; beam measurement report configuration for the beam measurement result; or a beam index. The beam measurement configuration may comprise beam measurement report configuration. The beam measurement report configuration may comprise at least one of: a beam RS measurement threshold; or a period for reporting the measurement result.

In some arrangements, the beam measurement configuration may comprise beam RS resource configuration for the beam RS. The beam RS resource configuration for the beam RS may comprise at least one of: a beam index, a frequency resource location for the beam RS; a time resource location for the beam RS; a period for a resource for the beam RS; a resource type (e.g. RSRP reference signal, CSI reference signal, SL-MIB, or SSB) for the resource for the beam RS; a slot index for a slot for the beam RS; a resource pool identifier (ID) for the beam RS; or an ID of the beam RS. The beam measurement configuration can be contained in at least one of a System Information Block (SIB), a Radio Resource Control (RRC) signaling, a Media Access Control (MAC) Control Element (CE), a Sidelink Control Signaling (SCI), or a resource pool configuration. The beam measurement configuration can be received from a network.

Some arrangements of the present disclosure relate to systems, methods, apparatuses, and non-transitory computer-readable media relating to communicating, by a second wireless communication device with a first wireless communication device, via a sidelink interface. The second wireless communication device may receive at least one of beam measurement configuration or beam Reference Signal (RS) from the first wireless communication device via the sidelink interface. The second wireless communication device may measure the beam RS using the beam measurement configuration. The second wireless communication device may send beam measurement result to the first wireless communication device via the sidelink interface. The beam measurement configuration may comprise at least one of: a beam RS measurement threshold; an indication indicating that the beam RS is present; an indication indicating that the second wireless communication device receiving the beam measurement configuration is to measure the beam RS; or an indication indicating that the second wireless communication device receiving the beam measurement configuration is to report the beam measurement result to the first wireless communication device.

In some arrangements, the second wireless communication device may send the beam measurement result in response to at least one of: determining that the beam measurement result is lower than a beam RS measurement threshold; determining beam failure of a beam in the sidelink interface; determining that the beam measurement result is to be sent according to periodicity; receiving a first message from the first wireless communication device, the first message comprising at least one of a Sidelink-Signaling Radio Bearer (SL-SRB) message, a Direct Communication Request (DCR) message, or a DCR response message. The beam measurement result may comprise at least one of: a measurement value of the beam RS; a recommended beam to be used for communication; a preferred beam to be used for communication; a non-preferred beam for communication; a candidate beam to be used for communication; an identifier (ID) of the beam measurement configuration; a slot index for a slot for the beam RS; a slot number for the slot for the beam RS; an ID of the beam RS; a beam index; an ID of a candidate beam RS, the candidate beam RS being recommended by the second wireless communication; an ID of a beam RS of a plurality of beam RSs that has a best measured value; or a slot index for a slot for the beam RS.

In some arrangements, the measurement value may comprise at least one of RSRP value or CSI value. The recommended beam, the preferred beam, the non-preferred beam, or the candidate beam can be identified by at least one of: the ID of the beam measurement configuration; the ID of the beam RS; or the beam index.

Some arrangements of the present disclosure relate to systems, methods, apparatuses, and non-transitory computer-readable media relating to communicating, by a first wireless communication device with a second wireless communication device, via a sidelink interface. The first wireless communication device may determine a beam failure on the sidelink interface. In response to determining the beam failure, the first wireless communication device may perform at least one of: starting a beam recovery procedure; sending a beam indication signal indicating beam failure is detected; sending a beam measurement configuration; starting a beam measurement sweeping procedure; triggering a resource re-selection; or triggering a resource pool re-selection. The beam recovery procedure may include at least one of: sending, by the first wireless communication device to the second communication device via the sidelink interface, a beam recovery signal; starting a beam recovery timer; or receiving a beam recovery response signal is received from the second wireless communication device. The first wireless communication device may determine the beam failure in response to at least one of: determining that a number of consecutive absent Physical Sidelink Feedback Channel (PSFCH) reaches a threshold; in response to receiving an indication from a sidelink RLC entity indicating that a maximum number of retransmissions for a specific destination has been reached; in response to determining that T400 for a specific destination has expired; in response to receiving an indication from MAC entity that a maximum number of consecutive HARQ DTX for the specific destination has been reached; in response to receiving an integrity check failure indication from sidelink PDCP entity concerning SL-SRB2 or SL-SRB3 for a specific destination; or receiving a beam indication signal indicating beam failure is detected.

In some arrangements, in response to detecting the beam failure, sending, by the first wireless communication device to a network, at least one of: an indication that the beam failure is detected; or a destination layer 2 identifier (ID) of a beam on which the beam failure is detected. The first wireless communication device may determine the beam recovery procedure has failed in response to at least one of: the first wireless communication device failing to receive the beam recovery response signal from the second wireless communication device; or beam recovery timer expiry. The first wireless communication device may determine the beam recovery procedure is successful in response to at least one of: receiving the beam recovery response signal from the second wireless communication device; receiving the beam recovery response signal from the second wireless communication device and beam recovery timer is running; the sidelink BWP is re-configured; the sidelink resource pool is re-configured; or the beam RS is re-configured. The beam recovery signal may comprise at least one of beam measurement configuration, beam measurement result. The beam recovery response signal may comprise at least one of beam measurement result, HARQ feedback, new sidelink transmission identified by a sidelink control information (SCI). In response to determining that a beam recovery procedure has failed, the first wireless communication device may determine that radio link failure (RLF) is detected. The HARQ feedback can be at least one of a positive acknowledgement or negative acknowledgement.

Some arrangements of the present disclosure relate to systems, methods, apparatuses, and non-transitory computer-readable media relating to communicating, by a second wireless communication device with a first wireless communication device, via a sidelink interface. The second wireless communication device may receive a beam recovery signal from the first wireless communication device via the sidelink interface. The second wireless communication device may send beam recovery response signal to the first wireless communication device via the sidelink interface. The second wireless communication device may determine a beam failure on the sidelink interface. The second wireless communication device may send a beam failure indication signal to the first wireless communication device. The first wireless communication device may perform a beam recovery procedure in response to receiving the beam failure indication signal. The beam failure indication signal may comprise at least one of: beam measurement result; or an indication that the beam failure is detected.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1A is a diagram illustrating an example wireless communication network, according to various arrangements.

FIG. 1B is a diagram illustrating a block diagram of an example wireless communication system for transmitting and receiving downlink, uplink, and/or SL communication signals, according to various arrangements.

FIG. 2 illustrates an example scenario for SL communication, according to various arrangements.

FIG. 3 is a flowchart diagram illustrating an example method for device-to-device communications on Frequency Range 2 (FR2), according to various arrangements.

FIG. 4 is a flowchart diagram illustrating an example method for device-to-device communications on Frequency Range 2 (FR2), according to various arrangements.

FIG. 5 is a flowchart diagram illustrating an example method for device-to-device communications on Frequency Range 2 (FR2), according to various arrangements.

FIG. 6 is a diagram illustrating beam measurement configuration transmissions, according to various arrangements.

FIG. 7 is a diagram illustrating beam measurement configuration transmissions, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

With the advent of wireless multimedia services, users' demand for high data rate and user experience continue to increase, which sets forth higher requirements on the system capacity and coverage of traditional cellular networks. In addition, public safety, social networking, close-range data sharing, and local advertising have gradually expanded the need for Proximity Services, which allow users to understand and communicate with nearby users or objects. The traditional network-centric cellular networks have limited high data rate capabilities and support for proximity services. In this context, device-to-device (D2D) communications emerge to address the shortcomings of the network-centric models. The application of D2D technology can reduce the burden of cellular networks, reduce battery power consumption of UEs, increase data rate, and improve the robustness of network infrastructure, thus meeting the above-mentioned requirements of high data rate services and proximity services. D2D technology is also referred to as Proximity Services (ProSe), unilateral/sidechain/SL communication, and so on.

To improve the reliability, data rate, latency of SL communications, Carrier Aggregation (CA) can be implemented for SL communications. In CA, two or more Component Carriers (CCs) are aggregated in order to support wider transmission bandwidths in the frequency domain. In some examples, a vehicle UE can simultaneously perform SL reception and transmission on one or multiple CCs. The arrangements disclosed herein relate to data split and data duplication based on CA.

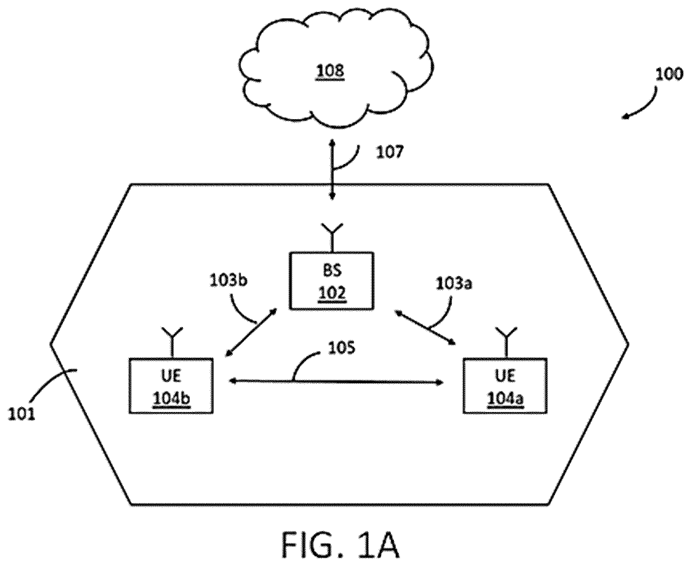

Referring to FIG. 1A, an example wireless communication network 100 is shown. The wireless communication network 100 illustrates a group communication within a cellular network. In a wireless communication system, a network side communication node or a Network can include a next Generation Node B (gNB), an E-UTRAN Node B (also known as Evolved Node B, eNodeB or eNB), a pico station, a femto station, a Transmission/Reception Point (TRP), an Access Point (AP), or so on. A terminal side node or a UE can include a device such as, for example, a mobile device, a smart phone, a cellular phone, a Personal Digital Assistant (PDA), a tablet, a laptop computer, a wearable device, a vehicle with a vehicular communication system, or so on. In FIG. 1A, a network side and a terminal side communication node are represented by a Network 102 and UEs 104a and 104b, respectively. In some arrangements, the Network 102 and UEs 104a/104b are sometimes referred to as “wireless communication node” and “wireless communication device,” respectively. Such communication nodes/devices can perform wireless communications.

In the illustrated arrangement of FIG. 1A, the Network 102 can define a cell 101 in which the UEs 104a and 104b are located. The UEs 104a and/or 104b can be moving or remain stationary within a coverage of the cell 101. The UE 104a can communicate with the Network 102 via a communication channel 103a. Similarly, the UE 104b can communicate with the Network 102 via a communication channel 103b. In addition, the UEs 104a and 104b can communicate with each other via a communication channel 105. The communication channels 103a and 104b between a respective UE and the Network can be implemented using interfaces such as an Uu interface, which is also known as Universal Mobile Telecommunication System (UMTS) air interface. The communication channel 105 between the UEs is a SL communication channel and can be implemented using a PC5 interface, which is introduced to address high moving speed and high density applications such as, for example, D2D communications, Vehicle-to-Vehicle (V2V) communications, Vehicle-to-Pedestrian (V2P) communications, Vehicle-to-Infrastructure (V2I) communications, Vehicle-to-Network (V2N) communications, or the like. In some instances, vehicle network communications modes can be collective referred to as Vehicle-to-Everything (V2X) communications. The Network 102 is connected to Core Network (CN) 108 through an external interface 107, e.g., an Iu interface.

In some examples, a remote UE (e.g., the UE 104b) that does not directly communicate with the Network 102 or the CN 108 (e.g., the communication channel link 103b is not established) communicates indirectly with the Network 102 and the CN 108 using the SL communication channel 105 via a relay UE (e.g., the UE 104a), which can directly communicate with the Network 102 and the CN 108 or indirectly communicate with the Network 102 and the CN 108 via another relay UE that can directly communicate with the Network 102 and the CN 108.

FIG. 1B illustrates a block diagram of an example wireless communication system for transmitting and receiving downlink, uplink and SL communication signals, in accordance with some arrangements of the present disclosure. In some arrangements, the system can transmit and receive data in a wireless communication environment such as the wireless communication network 100 of FIG. 1A, as described above.

The system generally includes the Network 102 and UEs 104a and 104b, as described in FIG. 1A. The Network 102 includes a Network transceiver module 110, a Network antenna 112, a Network memory module 116, a Network processor module 114, and a network communication module 118, each module being coupled and interconnected with one another as necessary via a data communication bus 120. The UE 104a includes a UE transceiver module 130a, a UE antenna 132a, a UE memory module 134a, and a UE processor module 136a, each module being coupled and interconnected with one another as necessary via a data communication bus 140a. Similarly, the UE 104b includes a UE transceiver module 130b, a UE antenna 132b, a UE memory module 134b, and a UE processor module 136b, each module being coupled and interconnected with one another as necessary via a data communication bus 140b. The Network 102 communicates with the UEs 104a and 104b via one or more of a communication channel 150, which can be any wireless channel or other medium known in the art suitable for transmission of data as described herein.

The system may further include any number of modules other than the modules shown in FIG. 1B. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

A wireless transmission from an antenna of one of the UEs 104a and 104b to an antenna of the Network 102 is known as an uplink transmission, and a wireless transmission from an antenna of the Network 102 to an antenna of one of the UEs 104a and 104b is known as a downlink transmission. In accordance with some arrangements, each of the UE transceiver modules 130a and 130b may be referred to herein as an uplink transceiver, or UE transceiver. The uplink transceiver can include a transmitter and receiver circuitry that are each coupled to the respective antenna 132a and 132b. A duplex switch may alternatively couple the uplink transmitter or receiver to the uplink antenna in time duplex fashion. Similarly, the Network transceiver module 110 may be herein referred to as a downlink transceiver, or Network transceiver. The downlink transceiver can include RF transmitter and receiver circuitry that are each coupled to the antenna 112. A downlink duplex switch may alternatively couple the downlink transmitter or receiver to the antenna 112 in time duplex fashion. The operations of the transceivers 110 and 130a and 130b are coordinated in time such that the uplink receiver is coupled to the antenna 132a and 132b for reception of transmissions over the wireless communication channel 150 at the same time that the downlink transmitter is coupled to the antenna 112. In some arrangements, the UEs 104a and 104b can use the UE transceivers 130a and 130b through the respective antennas 132a and 132b to communicate with the Network 102 via the wireless communication channel 150. The wireless communication channel 150 can be any wireless channel or other medium known in the art suitable for downlink and/or uplink transmission of data as described herein. The UEs 104a and 104b can communicate with each other via a wireless communication channel 170. The wireless communication channel 170 can be any wireless channel or other medium suitable for SL transmission of data as described herein.

Each of the UE transceiver 130a and 130b and the Network transceiver 110 are configured to communicate via the wireless data communication channel 150, and cooperate with a suitably configured antenna arrangement that can support a particular wireless communication protocol and modulation scheme. In some arrangements, the UE transceiver 130a and 130b and the Network transceiver 110 are configured to support industry standards such as the Long Term Evolution (LTE) and emerging 5G and 6G standards, or the like. It is understood, however, that the present disclosure is not necessarily limited in application to a particular standard and associated protocols. Rather, the UE transceiver 130a and 130b and the Network transceiver 110 may be configured to support alternate, or additional, wireless data communication protocols, including future standards or variations thereof.

The processor modules 136a and 136b and 114 may be each implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, methods and algorithms described in connection with the arrangements disclosed herein may be embodied directly in hardware, in firmware, in a software module executed by processor modules 114 and 136a and 136b, respectively, or in any practical combination thereof. The memory modules 116 and 134a and 134b may be realized as RAM memory, flash memory, ROM memory, EPROM memory, EEPROM memory, registers, a hard disk, a removable disk, a CD-ROM, or any other form of storage medium known in the art. In this regard, the memory modules 116 and 134a and 134b may be coupled to the processor modules 114 and 136a and 136b, respectively, such that the processors modules 114 and 136a and 136b can read information from, and write information to, memory modules 116 and 134a and 134b, respectively. The memory modules 116, 134a, and 134b may also be integrated into their respective processor modules 114, 136a, and 136b. In some arrangements, the memory modules 116, 134a, and 134b may each include a cache memory for storing temporary variables or other intermediate information during execution of instructions to be executed by processor modules 116, 134a, and 134b, respectively. Memory modules 116, 134a, and 134b may also each include non-volatile memory for storing instructions to be executed by the processor modules 114 and 136a and 136b, respectively.

The network interface 118 generally represents the hardware, software, firmware, processing logic, and/or other components of the Network 102 that enable bi-directional communication between Network transceiver 110 and other network components and communication nodes configured to communication with the Network 102. For example, the network interface 118 may be configured to support internet or WiMAX traffic. In a typical deployment, without limitation, the network interface 118 provides an 802.3 Ethernet interface such that Network transceiver 110 can communicate with a conventional Ethernet based computer network. In this manner, the network interface 118 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 118 can allow the Network 102 to communicate with other Network s or core network over a wired or wireless connection.

In some arrangements, each of the UEs 104a and 104b can operate in a hybrid communication network in which the UE communicates with the Network 102, and with other UEs, e.g., between 104a and 104b. As described in further detail below, the UEs 104a and 104b support SL communications with other UE's as well as downlink/uplink communications between the Network 102 and the UEs 104a and 104b. In general, the SL communication allows the UEs 104a and 104b to establish a direct communication link with each other, or with other UEs from different cells, without requiring the Network 102 to relay data between UEs.

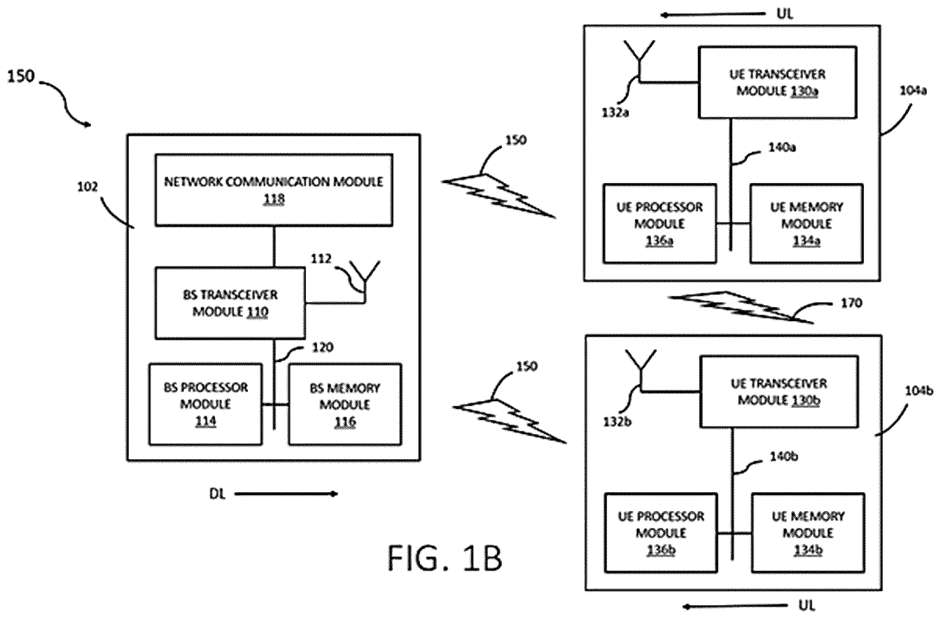

FIG. 2 is a diagram illustrating an example system 200 for SL communication, according to various arrangements. As shown in FIG. 2, a Network 210 (such as Network 102 of FIG. 1A) broadcasts a signal that is received by a first UE 220, a second UE 230, and a third UE 240. The UEs 220 and 230 in FIG. 2 are shown as vehicles with vehicular communication networks, while the UE 240 is shown as a mobile device. As shown by the SLs, the UEs 220-240 are able to communicate with each other (e.g., directly transmitting and receiving) via an air interface without forwarding by the base station 210 or the core network 250. This type of V2X communication is referred to as PC5-based V2X communication or V2X SL communication.

As used herein, when two UEs 104a or 104b are in SL communications with each other via the communication channel 105/170, the UE that is transmitting data to the other UE is referred to as the transmission (TX) UE, and the UE that is receiving said data is referred to as the reception (RX) UE.

With the development of wireless multimedia services, people's demand for high data rate and user experience is increasing, which may put forward higher requirements on system capacities and coverages of traditional cellular networks. On the other hand, application scenarios, such as public security, social networks, short-distance data sharing, and local advertising, have gradually increased people's demand for understanding and communicating with nearby people or things (e.g., proximity services). Traditional base station-centric cellular networks may have limitations in terms of high data rates and supports for proximity services. A device-to-device (D2D) communication technology emerges in response to the demand. An application of the D2D communication technology may reduce a burden of a cellular network, may reduce a battery power consumption of a user equipment, may increase a data rate, and/or may improve a robustness of a network infrastructure, which can well meet the requirements of the above-mentioned high data rate business and proximity services. D2D technology can be also called Proximity Services (ProSe), unilateral/sidelink (SL) communication. An interface between devices can be a PC5 interface.

Device using/utilizing/applying sidelink communication may support two resource modes (e.g., mode 1 and mode 2). For mode 1, a UE may use a resource scheduled by a network to transmit sidelink data. For mode2, a UE may select a transmission resource by itself to transmit sidelink data.

Wireless communications can be performed on carriers or frequency bands. Two different frequency ranges (e.g., Frequency Range 1 (FR1) and Frequency Range 2 (FR2)) may be available for 5G technology including a sidelink. The two difference frequency ranges have been designated as FR1 and FR2. Frequency bands in range of the FR1 can be envisaged/assumed to carry much of the traditional cellular mobile communications traffic. Higher frequency bands in range of the FR2 can be aimed at/designed for providing short range very high data rate capability for a 5G radio. With a 5G wireless technology anticipated to carry much higher speed data, the additional bandwidth of these higher frequency bands may be needed/demanded.

Originally, the FR1 band was intended to define bands below 6 GHz, but with anticipated additional spectrum allocations, the FRI range was extended to 7.125 GHz. Currently, user terminal devices may be able to communicate directly with each other (e.g., without use of a base station) on a carrier within FR1. To improve the data rate, this disclosure describes how to apply sidelink communication on carrier within FR2.

When using low and middle ranges of frequency, a signal may be transmitted in all directions or relatively wide angles. However, when using very high frequency (e.g., carriers in FR2), there may be not much choice except using a huge antenna array. As a result of using the huge antenna array, a resulting radiation may be a beam. A corresponding technology can be called beamforming. For a wireless communication device, each beam may occupy a specific direction. By adopting different transmission parameters, the wireless communication device can control a direction of a beam. However, when communicating with other devices, the beam may be used and whether the used beam still works well may need to be handled/investigated.

To select a best beam for communication, a first UE may transmit a beam reference signaling (RS), and a second UE may measure the beam RS. The second UE may send the beam measurement result to the first UE. Based on the received beam measurement result, the first UE may know/be aware of which beam can be adopted.

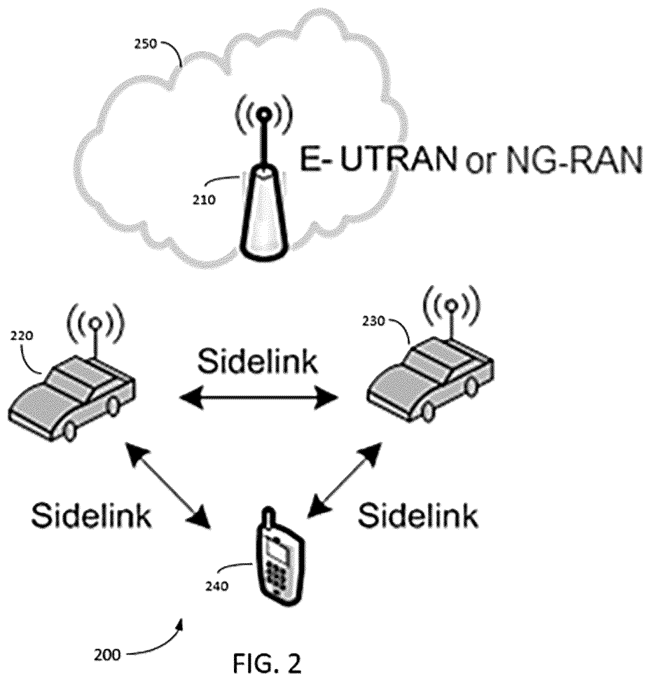

FIG. 3 is a flowchart diagram illustrating an example method for device-to-device communications using beamforming, according to various arrangements. In some arrangements, a first wireless communication device (e.g., a first UE) may communicate with a second wireless communication device (e.g., a second UE) via a sidelink interface.

In some arrangements, a first wireless communication device (e.g., a first UE) may transmit a beam measurement configuration and/or beam reference signaling (RS) to a second wireless communication device (e.g., a second UE).

In some arrangements, a first wireless communication device may start a beam measurement procedure. When the beam measurement procedure is started, the first UE may transmit a beam measurement configuration and/or beam reference signaling (RS) to a second wireless communication device.

In some arrangements, the beam RS can be a reference signal received power (RSRP) reference signal, a channel state information (CSI) reference signal, a slidelink mater information block (SL-MIB), or a synchronization signal block (SSB), or a Sounding Reference Signals (SRS).

The second wireless communication device may report a measurement result to the first wireless communication device. The first wireless communication device may receive beam measurement result from the second wireless communication device via the sidelink interface. Based on the received beam measurement result, the first wireless communication may know/be aware of/determine which beam can be used for sidelink communication or whether the selected beam still works/operates/functions properly.

In some arrangements, the first UE may not always transmit the beam RS on one sidelink resource, therefore, to make the second UE know/be aware of whether the beam RS is present or not, and/or the resource location of beam RS. The beam measurement configuration may include at least one of: (1) an indication on whether the beam RS is present; (2) an indication on whether the second wireless communication device (e.g., the second UE) receiving this configuration is to measure the beam RS; (3) an indication on whether the second wireless communication device (e.g., the second UE) receiving this configuration is to report the beam measurement result the first wireless communication device (e.g., the first UE); (4) resource configuration for the beam RS; (5) an identifier (ID) of the beam measurement configuration; or (6) beam measurement report configuration for the beam measurement result; or (7) a measurement request indicating whether the second wireless communication device is to report the beam measurement result.

In some arrangements, the first UE may include the measurement report configuration in beam measurement configuration to make the second UE know/be aware of when to send the beam measurement result. The beam measurement report configuration may include beam RS measurement threshold. The beam RS measurement threshold can be an RSRP threshold. If the measurement result of the beam RS is lower than the beam RS measurement threshold, the second UE may send the beam measurement result to the first UE. In another arrangement, not all measurement result needs to be sent to first UE, the second UE may include at least one of: an ID of the beam RS, or an ID of the beam measurement configuration, when the corresponding measurement result of beam RS is higher than the beam RS measurement threshold. In another arrangement, the beam measurement report configuration may include a period of reporting the measurement result. The second UE may send the beam measurement result to the first UE periodically.

In some arrangements, the first UE may include the beam RS resource configuration in beam measurement configuration to make the second UE know/be aware of the detailed information of beam RS. The beam RS resource configuration may include at least one of: an ID of the beam RS, a frequency resource location for the beam RS (e.g., a frequency resource on which the beam RS is carried), a time resource location for the beam RS (e.g., a time resource on which the beam RS is carried), a beam RS transmission period for a resource for the beam RS (e.g., a beam RS transmission period), a offset for a resource for the beam RS, a beam RS type (e.g., the beam RS can be at least one of a reference signal received power (RSRP) reference signal, a channel state information (CSI) reference signal, a slidelink mater information block (SL-MIB), a synchronization signal block (SSB)) for the resource for the beam RS, a slot index of the beam RS (e.g. the slot index on which the beam RS is carried), or a resource pool ID of the beam RS (e.g., ID of the a resource pool on which the beam RS is carried).

In some arrangements, the first UE may transmit different beam RS in different resource or with different configuration. The beam measurement configuration may include an ID to identify the beam measurement configuration. The ID of beam measurement configuration can be at least one of: a beam index, an ID of the beam RS, or an ID of the beam measurement configuration.

In some arrangements, the beam measurement configuration can be included in at least one of: a system information block (SIB), a radio resource control (RRC) signaling, a resource pool configuration, a Medium Access Control (MAC) control element (CE), or a sidelink control information (SCI).

In some arrangements, the first UE may be under control of the network. The beam measurement configuration can be configured by the network. In some arrangements, the first UE may communicate with more than one second UEs. To identify the second UE to which the beam measurement configuration belongs, the beam measurement configuration may include an ID of the second UE. The ID of the second UE can be a destination layer2 ID. In some arrangements, when the first UE transmits the beam measurement configuration to second UE, to ensure the quality of service (QoS) of beam measurement configuration, the beam measurement configuration received from network may include a latency bound of beam measurement configuration. The latency bound indicates the latency requirement of the corresponding message.

In another arrangement, the latency bound of beam measurement configuration indicates the latency bound of the beam measurement procedure. In other words, the latency bound indicates N beam measurement configurations, N is an integer.

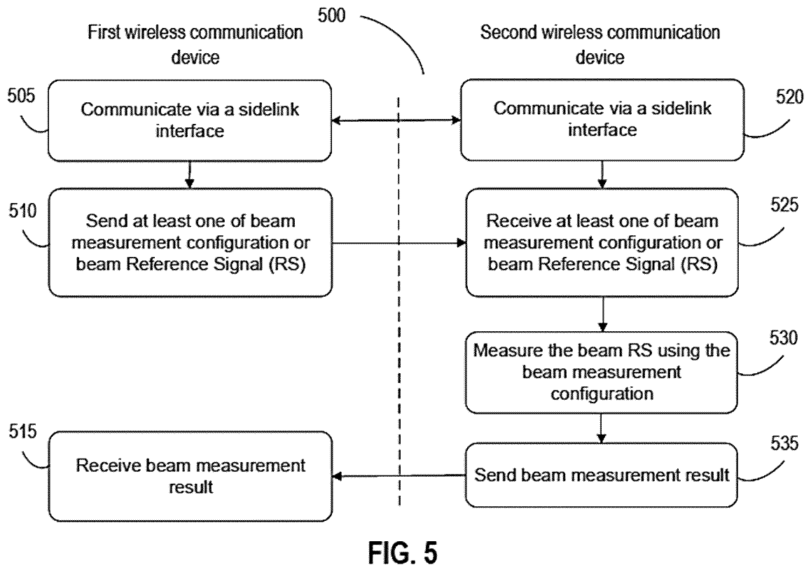

An example implementation can be shown in FIG. 6. FIG. 6 is a diagram illustrating beam measurement configuration transmissions 610, according to various arrangements. As shown in FIG. 6, a latency bound 620 of the beam measurement procedure can indicate N=6 beam measurement configuration transmissions 610. Two beam measurement configuration transmissions 610 are outside of the latency bound 630.

In one arrangements, since channel may change rapidly, the beam measurement result may be also changed rapidly. The first UE may need to obtain the beam measurement result as soon as possible. Therefore, the beam measurement configuration may include at least one of: a latency bound of the beam measurement result, or a packet delay budget of the beam measurement result.

In one arrangements, in order to select a best beam (e.g., spatial direction), the first UE may start a beam sweeping procedure to transmit beam RS in different beam directions to determine how many beam directions can be used according to UE's implementation or UE's capability. After finishing beam sweeping, the first UE may obtain the measurement result of different beam from the second UE. The first UE may know/be aware of/determine which beam is a best beam based on the measurement result. The beam sweeping procedure can be that first UE transmits the beam RS in different beam directions, and the second UE measures the beam RS in different beam directions. The second UE may report the measurement to the first UE. Therefore, to complete the beam sweeping procedure, except transmitting beam RS in different directions, the first UE may transmit the corresponding beam measurement configuration to trigger and to obtain the beam measurement result of beam RS in different beam directions. As a result, when beam measurement procedure is started, the first UE may transmit N the beam measurement configurations. N is integer.

In one arrangements, the first UE may start the beam measurement procedure periodically to monitor the channel quality. The first UE may maintain a beam measurement timer. Upon/when the beam measurement procedure is started, the first UE may start the beam measurement timer. Upon/when the beam measurement timer expires, the first UE may start the beam measurement procedure. In some arrangements, the beam measurement timer can be included in the beam measurement configuration.

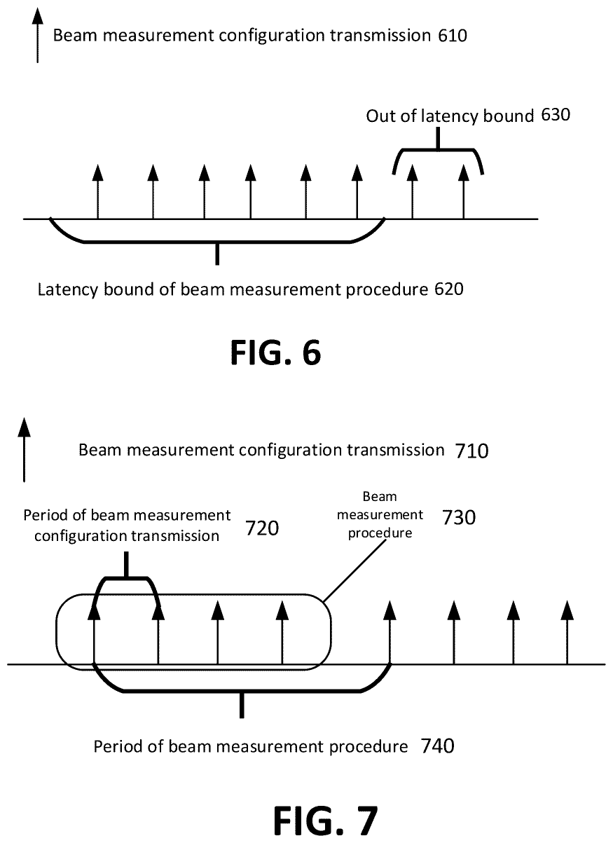

Upon/when the beam measurement procedure is started, the first UE can transmit one or more beam measurement configuration to the second UE. The number of beam measurement configuration may depend/be based on the first UE's implementation, but the maximum number of beam measurement configuration transmission can be configured by a network or a second UE. The beam measurement configuration may include a maximum number of beam measurement configuration transmission. For example, the first UE may obtain beam measurement results of four beams in different beam direction, then the first UE may transmit four beam measurement configurations. After finishing all transmission of beam measurement configurations, the first UE may stop the beam measurement procedure. An example implementation is shown in FIG. 7, which is a diagram illustrating beam measurement configuration transmissions 710, according to various arrangements. The period 720 of beam measurement configuration transmission is the beam configuration transmission timer, and the period 740 of beam measurement procedure is beam measurement timer.

In some arrangements, the first UE may be under the control of network, to perform the beam measurement procedure 730. In performing the beam measurement procedure 730 the first UE may report at least one of following to network for resource allocation: (1) the period 720 of beam measurement configuration transmission (e.g., beam configuration transmission timer), the period 740 of beam measurement procedure (e.g., beam measurement timer), or the latency bound (e.g., 620) of beam measurement procedure, or the maximum number of beam measurement configuration transmissions.

In some arrangements, the latency bound can be the packet delay budget.

In some arrangements, when a beam measurement procedure is started, the number of beam measurement configuration transmission may depend/be based on the first UE's capability. In some arrangements, upon/when the beam measurement procedure is started, to transmit N beam measurement configurations, the first UE may start a beam configuration transmission timer. Upon/when the beam configuration transmission timer expires, the first UE may transmit a beam measurement configuration. In another arrangements, when the first UE has transmitted one beam measurement configuration, the first UE may transmit another beam measurement configuration.

In some arrangements, upon/when the number of beam measurement configuration transmission reaches a maximum beam measurement configuration transmission number, the first UE may stop the beam measurement procedure. In some arrangements, upon/when the number of beam measurement configuration transmission reaches a maximum beam measurement configuration transmission number, the first UE may stop the beam configuration transmission timer.

In some arrangements, when the first UE is going to establish a unicast link, the first UE may prefer to select a best beam for a data transmission. The first UE may start a beam measurement procedure to select a best beam. Similarly, when the DCR message is generated and the first UE is going to establish a unicast link, the first UE may start an initial beam sweeping for selecting a best beam. Similarly, when the sidelink SRB message is generated (e.g., SRB0 message, DCR message, Direct link establishment request message) and the first UE is going to establish a unicast link, the first UE may start an initial beam sweeping for selecting a best beam. To establish a unicast link, the first UE and the second UE may exchange at least one of following message: a DCR message, a DCR response message, a direct link establishment request message, a direct link establishment response message, Direct Link Security Mode Command, Direct Link Security Mode Complete, a sidelink SRB message, or a sidelink discovery message.

In some arrangements, when the beam failure is detected, the first UE may select another beam for data transmission. The first UE may start a beam measurement procedure to select a best beam. Similarly, when the beam RS measurement value of current selected beam is lower than a configured beam RS threshold, the current beam can be not suitable for data transmission. The first UE may start a beam measurement procedure for selecting a best beam.

In some arrangements, the first wireless communication device may receive a beam measurement result that is lower than a beam RS measurement threshold, meaning that the current beam is not a suitable beam for communication The first wireless communication device may start a beam measurement procedure to select another beam for communication.

In some arrangements, the first wireless communication device (e.g., the first UE) may start the beam measurement procedure when at least one of following happens: the first UE is going to establish a unicast link, the first wireless communication device transmits a first message (e.g., a sidelink-signaling radio bearer (SL-SRB) message, a direct communication request (DCR) message, a DCR response message, a direct link establishment request message, a direct link establishment response message, Direct Link Security Mode Command, Direct Link Security Mode Complete, a sidelink SRB message, a sidelink discovery message), when the beam failure is detected, or beam measurement result is lower than a beam RS measurement threshold, or a beam recovery signaling is received, or a beam recovered procedure is started. The first UE can multiplex the measurement configuration and the first message into same medium access control protocol data unit (MAC PDU).

In some arrangements, the first message can be at least one of: a sidelink-signaling radio bearer (SL-SRB) message, a direct communication request (DCR) message, a DCR response message, a direct link establishment request message, a direct link establishment response message, Direct Link Security Mode Command, Direct Link Security Mode Complete, a sidelink SRB message, a sidelink discovery message.

In some examples, the second UE may receive at least one of beam measurement configuration or beam Reference Signal (RS) from the first UE via the sidelink interface. The second UE may measure the beam RS using the beam measurement configuration. The second UE may transmit beam measurement result to the first UE via the sidelink interface.

In some examples, the second UE may start a beam measurement report procedure to send the beam measurement result to first UE. The second UE may maintain a beam report timer (e.g., beamreporttimer) for the beam measurement report procedure. The beam measurement report timer can be included in the beam measurement configuration. In some examples, the beam measurement report timer can be set to the latency bound of beam measurement result included in the beam measurement configuration.

An implementation example of the beam measurement report procedure can be shown in following:
1>if the beam measurement report procedure has been triggered and not cancelled:
   2>if the beam measurement report timer for the triggered beam measurement report procedure is not running:
      3>start the beam measurement report timer.
   2>if the beam measurement report expires:
      3>cancel the triggered beam measurement report procedure.
   2>else if the second UE has resources allocated for new transmission and the resources can accommodate the beam measurement result, the second UE performs at least one of following:
      3>generate a beam measurement result;
      3>stop the beam measurement report;
      3>cancel the triggered beam measurement report procedure.
   2>else if the second UE has been configured with Sidelink resource allocation mode 1:
      3>trigger a Scheduling Request.

There are some conditions for reporting the beam measurement result (or starting the beam measurement report procedure) by a wireless communication device. The second UE may report the beam measurement result to the first UE when the second UE receives the beam measurement configuration including at least one of: (1) an indication on whether the beam RS is present; (2) an indication on whether the second wireless communication device (e.g., the second UE) receiving the beam measurement configuration is to measure the beam RS; or (3) an indication on whether the second UE receiving the beam measurement configuration is to report the beam measurement result to the first UE, or (4) measurement request indicating whether the second UE is to report the beam measurement result.

To limit the number of measurement result report, some reporting conditions can be considered. In some arrangements, when the beam measurement result of the beam RS is lower than a beam RS measurement threshold included in beam measurement configuration, the second UE may report the beam measurement result to the first UE. In some arrangements, the second UE may report the beam measurement result to the first UE if a beam failure of a beam in the sidelink interface is detected. In some arrangements, the second UE may transmit the beam measurement result to the first UE periodically.

In some arrangements, the second UE may transmit the beam measurement result to the first UE in response to receiving the first message on PSSCH from the first UE. The first message may comprise at least one of: a Sidelink-Signaling Radio Bearer (SL-SRB) message, a Direct Communication Request (DCR) message, a DCR response message, a PC5-S message, a Direct Link Establishment request, a Direct Link Security Mode Complete, or a Discovery message. The second UE can multiplex the measurement result and the first message into same MAC PDU.

In some arrangements, to identify the beam measurement result belongs to which beam measurement configuration, the beam measurement result may include beam measurement configuration. The ID related information in beam measurement can be included in the beam measurement result, for example, (1) an identifier (ID) of the measurement configuration; (2) a slot index on which the beam RS is measured (e.g., a measured beam RS); (3) an ID of the beam RS, (4) beam index.

In some arrangement, the beam measurement result may include the Reference Signal Receiving Power (RSRP) value of the beam RS.

In some arrangements, it is possible that the second UE may communicate with a plurality of wireless communication devices (e.g., more than one transmit (TX) UE) via a plurality of sidelink interfaces. Therefore, a UE may not use same receive (RX) beam to receive data from a different TX UE. To avoid switching a beam frequently or when beam failure is detected, the second UE can provide some beam recommendation from the second UE's perspective. The beam measurement result may include a beam recommendation, the beam recommendation can be at least one of: (1) the recommended beam to be used for communication; (2) the preferred beam to be used for communication; (3) the non-preferred beam for communication; (4) candidate beam to be used for communication. In some arrangements, beam recommendation can be identified by at least one of: the ID of the beam measurement configuration, the ID of the beam RS, or a beam index. In the example in which four beams are used by first UE for communication and beam-1 has highest measurement result, the first UE can select beam-1 for communication with second UE. In the scenario in which the second UE may also need to receive the data from a third UE. Therefore, the second UE sends the beam recommendation indicating that the beam-2 is a preferred beam/recommended beam for communication. Alternatively, the second UE sends the beam recommendation indicating that the beam-1 is a non-preferred beam for communication. Then the first UE may not select beam-1 and may select beam-2 for communication with the second UE.

In some arrangement, before receiving the beam recommendation from second UE, the first UE can send at least one candidate beam to second UE. The beam measurement configuration may include the at least one candidate beam. When sending the beam recommendation, only a candidate beam included in beam measurement configuration can be selected as the beam recommendation.

In some arrangements, not all beams can be a suitable beam for communication, only the suitable beam having measurement result higher than a threshold can be included in the beam measurement result. When the beam RS measurement result of the recommended beam is higher than a beam RS measurement threshold, the beam measurement result can include the recommended beam. In some arrangements, when the beam RS measurement result of the preferred beam is higher than a beam RS measurement threshold, the beam measurement result can include the preferred beam. In some arrangements, when the beam RS measurement result of the candidate beam is higher than beam RS measurement threshold, the beam measurement result can include the candidate beam. When the beam RS measurement result of the beam recommendation is higher than a beam RS measurement threshold, the beam recommendation can be included in the beam measurement result.

When the first UE determines which beam may be use for communication, at least one of the following recommendations can be taken into consideration: (1) the recommended beam to be used for communication; (2) the preferred beam to be used for communication; (3) the non-preferred beam for communication; or (4) the candidate beam for communication.

In some arrangement, the first UE may need to transmit the beam measurement configuration as soon as possible, therefore the first UE may be configured with a latency bound of beam measurement configuration. The beam measurement configuration may include a beam measurement configuration.

There are some conditions for performing the measurement by a wireless communication device. In some arrangements, it is possible that a beam RS can be associated to the PSSCH transmission. For example, a beam RS and a PSSCH can be located in same slot. The first UE may only transmit the beam RS if the first UE transmits the PSSCH on same slot. In such case, if the second UE receives the first message on PSSCH from the first UE, the second UE may measure the beam RS and may obtain the beam RS measurement result to be reported to the first UE. If the second UE does not receive the first message on PSSCH from the first UE, the first UE may not transmit the beam RS on a corresponding resource of the beam RS.

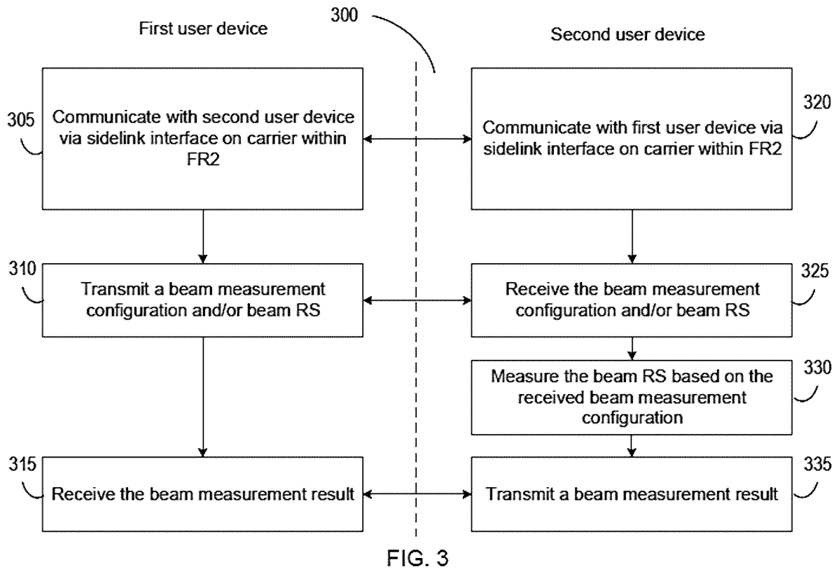

FIG. 4 is a flowchart diagram illustrating an example method for device-to-device communications on Frequency Range 2 (FR2), according to various arrangements. In some arrangements, a first wireless communication device (e.g., a first UE) may communicate with a second wireless communication device (e.g., a second UE) via a sidelink interface. The first wireless communication device (e.g., a first UE) may determine a beam failure on the sidelink interface. In response to determining the beam failure, the first wireless communication device may start a beam recovery procedure. For example, the beam recovery procedure can be: send a beam recovery signal to the second communication device via the sidelink interface. The first wireless communication device may determine whether beam recovery procedure is complete successfully or failure, for example, determine the beam recovery procedure is success if a beam recovery response signal is received from the second wireless communication device.

There are some conditions for detecting a beam failure by a wireless communication device. In some arrangements, upon/when a number of consecutive absent physical sidelink feedback channel (PSFCH) reception (e.g., how many times absent PSFCH reception occurs) reaches a configured maximum PSFCH absent value, a first wireless communication device (e.g., a first UE) may consider that a beam failure is detected.

The implementation example can be shown in following (numConsecutiveDTX is an counter):
1>if PSFCH reception is absent on the PSFCH reception occasion:
   2>increment numConsecutiveDTX by 1;
   2>if numConsecutiveDTX reaches maximum PSFCH absent value:
      3>considers the beam failure is detected.
1>else:
   2>re-initialize mimConsecutiveDTX to zero.

In some arrangements, in response to determining that the measurement result of beam RS is lower than the beam RS measurement threshold, the first UE considers the beam failure is detected.

In some embodiments, the first UE may consider that the beam failure is detected in response to at least following happens: (i) in response to receiving an indication from sidelink RLC entity that the maximum number of retransmissions has been reached; (ii) in response to determining that T400 has expired (T400 is started in response to a transmission of RRCReconfigurationSidelink message); (iii) in response to receiving an indication that the maximum number of consecutive HARQ DTX has been reached; or (iv) in response to receiving an integrity check failure indication from sidelink PDCP entity.

In some embodiment, the first UE may measure the beam RS to detect beam failure. If the first UE receives N beam failure indication from physical layer, N is an integer and N is higher than the maximum beam failure indication number, the first UE may consider/determine the beam failure is detected.

In some embodiments, the first UE may maintain a beam failure indication counter. If the first UE receives the beam failure indication from physical layer, the first UE may increment the beam failure indication counter by one. In response to the beam failure indication counter reach the maximum beam failure indication number, the first UE may consider/determine the beam failure is detected

In some embodiments, the first UE may maintain a beam failure detection timer. If the first UE receives the beam failure indication from physical layer, the first UE may start a beam failure detection timer. If the beam failure detection timer expires, the first UE may set the beam failure indication counter to zero. In some embodiments, the beam measurement configuration may include at least one of following: a beam failure detection timer, or the maximum beam failure indication number.

An example implementation can be shown in following:
1>if beam failure instance indication has been received from physical layers:
   2>start or restart the beamFailureDetection Timer;
   2>increment BFI_COUNTER by 1;
   2>if BFI COUNTER>=beamFailureInstanceMaxCount:
      3>considers the beam failure is detected;

In some arrangement, the first UE may not detect the beam failure by itself directly. For example, the first UE may determine that the beam failure is detected when receiving the beam failure indication from the second UE.

There are some transmit (TX) side actions after a beam failure is detected by a wireless communication device. In some arrangements, the first UE may be under the control of network. Therefore, the network may be aware of the beam failure. If a beam failure is detected, the first UE may report at least one of following to the network: (1) an indication that the beam failure is detected; or (2) a destination layer 2 identifier (ID) of a beam on which the beam failure is detected. In some arrangements, an indication that the beam failure is detected is included in the sidelink UE information message (SUI). If a beam failure is detected and beam recovery procedure is a failure, the first UE may report at least one of following to the network: (1) an indication that the beam failure is detected; or (2) a destination layer 2 identifier (ID) of a beam on which the beam failure is detected.

After starting a beam recovery procedure, the first UE may determine whether the recovery procedure is complete successfully or failure. In response to determining that the first UE does not receive the beam recovery response signal from the second UE, a beam recovery procedure is failed. In response to determining that the first UE receives the beam recovery response signal from the second UE, a beam recovery procedure is successful.

In some arrangements, upon/when the beam recovery procedure is performed, the first UE may transmit a beam recovery signal to the second UE. The beam recovery signal may comprise beam measurement configuration. The first UE may receive a beam recovery response signal from the second UE. The beam recovery response signal may comprise beam measurement result. In some arrangements, upon/when the first UE does not receive the beam recovery response signal from the second UE, the first UE may consider that a beam recovery procedure fails.

In some arrangements, the beam failure may be detected by the second UE, but the recovery procedure is started by the first UE. In such case, when the first UE initiates beam recovery procedure, the beam recovery signal may include a beam measurement configuration to trigger second UE measure the beam RS for selecting another beam. Meanwhile, the beam recovery response signal may include a beam measurement result for the first UE to select another beam.

In some arrangement, the beam recovery signaling may include a beam measurement result.

In some arrangement, the beam failure may be detected by the first UE and the recovery procedure can be started also by the first UE In such case, when the first UE initiates beam recovery procedure, the beam recovery signal may include a beam measurement result.

In some arrangements, the beam recovery response signal can be a hybrid automatic repeat request (HARQ) feedback on PSFCH.

In some arrangement, after transmitting one beam recovery signal, if the first UE does not receive the beam recovery response signaling, the first UE may re-transmit the beam recovery signal. In response to number of beam recovery signal transmission reaching the maximum beam recovery signal transmission number, the first UE stop transmitting the beam recovery signal. If first UE still not receive the beam recovery response signal, the first UE considers that the beam recovery procedure is failure. The beam measurement configuration may include a maximum beam recovery signal transmission number.

In some arrangement, the second UE needs to send the beam recovery response signal as soon as possible, therefore, the first UE may set a latency bound of beam recovery response signal to second UE. The beam measurement configuration may include a latency bound of beam recovery response signal.

In some arrangement, the first UE may need to transmit the beam recovery signal as soon as possible to finish the recovery procedure, therefore, the first UE may be configured with a latency bound of beam recovery signal from network. The beam measurement configuration may include a latency bound of beam recovery signal.

In some arrangement, since the first UE may select sidelink resource by itself (e.g., sidelink resource allocation mode2), after beam failure is detected, the first UE may trigger at least one of: resource re-selection or resource pool re-selection.

In some arrangements, the beam recovery response signal can be a new sidelink transmission indicated by SCI.

In some arrangements, the first UE may consider that the beam is recovered (e.g., the beam recovery procedure is successful) if the first UE receives the beam recovery response signal.

In some arrangements, upon/when the beam recovery is performed, the first UE may start a beam recovery timer. Upon/when the beam recovery timer expires, the first UE may consider that the beam recovery is failed. Upon/when the beam failure recovery is complete successful, the first UE may stop the beam recovery timer. In some arrangements, the beam recovery timer may be included in the beam measurement configuration.

In response to determining that a beam recovery procedure has failed, the first UE may determine a radio link failure (RLF) is detected.

There are some receive (RX) side actions after a beam failure is detected by a second wireless communication device. In some examples, the second UE may receive a beam recovery signal from the first UE via the sidelink interface. The second UE may send beam recovery response signal to the first UE via the sidelink interface. In some arrangements, upon/when a beam failure is detected, the second UE may transmit a beam failure indication signal to the first UE.

In some arrangements, the beam failure indication signal may include at least one of: (1) beam measurement result; or (2) an indication that the beam failure is detected; or (3) beam measurement result.

In some arrangements, in response to receiving the beam failure indication signal from the second UE, the first UE may perform a beam recovery procedure.

In some embodiments, the beam recovery response message can be a HARQ ACK or a NACK message on physical sidelink feedback channel (PSFCH).

In some arrangements, if the measurement result is higher than a beam RS measurement threshold, the first UE may consider/determine that the beam recovery procedure is complete successful.

In some arrangements, in response to determining that the measurement result is lower than a beam RS measurement threshold, the first UE may consider/determine that the beam recovery procedure is failure.

In some arrangements, the second UE may measure the beam RS using the beam measurement configuration.

It should be understood that one or more features from the above implementation examples are not exclusive to the specific implementation examples, but can be combined in any manner (e.g., in any priority and/or order, concurrently or otherwise).

Some implementation examples are shown in followings:

### EXAMPLE 1

Step 1: The first UE may send a Direct communication request message (DCR) to the second UE to establish unicast link.
Step 2: Since the first UE wants to establish a unicast link, the first UE may start a beam measurement procedure to transmit N beam measurement configuration messages and M beam RSs to the second UE periodically. N and M are integer. The N and M can be determined based on the first UE's capability.
Step 3: The second UE may receive the DCR message, beam measurement configuration message, and beam RS. Since the second UE knows that the first UE wants to establish unicast link. Based on the beam measurement configuration, the second UE may measure the beam RS and generate the beam measurement result. The second UE may start a beam measurement procedure to transmit N beam measurement configuration message and M beam RS to select beam for data transmission from the second UE to the first UE.
Step 4: The second UE may send the beam measurement result to the first UE.

### EXAMPLE 2 (FIRST UE DETECTS BEAM FAILURE AND INITIATE RECOVERY PROCEDURE, INITIATES BEAM MEASUREMENT PROCEDURE)

Step 1: The beam failure can be detected by the first UE.
Step 2: When the beam failure is detected, the first UE may start a beam measurement procedure to transmit N beam measurement configuration messages and M beam RSs to the second UE periodically. N and M are integer. The N and M can be determined based on first UE's capability. The first UE may start a beam recovery procedure to transmit beam recovery signal to the second UE. If the beam recovery procedure is started, the first UE may start a beam recovery timer.
Step 3: The first UE may receive the beam measurement result and the beam recovery response message from the second UE. If the beam recovery response message is received and the beam recovery time is running, the first UE may consider/determine that the beam recovery procedure is complete successfully and may stop the beam recovery timer. If the beam recovery time expires, the first UE may consider/determine that the beam recovery procedure is failure and may consider/determine that the RLF is detected.

### EXAMPLE 3 (FIRST UE DETECTS BEAM FAILURE AND INITIATES BEAM MEASUREMENT PROCEDURE, SECOND UE INITIATES RECOVERY PROCEDURE)

Step1: The beam failure is detected by the first UE.
Step2: When the beam failure is detected, the first UE transmit a beam failure indication to second UE. And The first UE start a beam measurement procedure to transmit N beam measurement configuration messages and M beam RSs to second UE periodically. N and M are integer, and depend on first UE's capability.
Step3: After receiving the beam failure indication, second UE start a beam recovery procedure to transmit beam recovery signal to first UE. If the beam recovery procedure is started, the second UE start a beam recovery timer.
Step4: The second UE receives the beam recovery response signal from first UE. If the beam recovery response message is received and the beam recovery time is running, the second UE considers the beam recovery procedure is complete successfully and stop the beam recovery timer. If the beam recovery time expiry, the second UE considers the beam recovery procedure is failure and considers the RLF is detected.

### EXAMPLE 4 (FIRST UE DETECTS BEAM FAILURE AND INITIATES BEAM RECOVERY PROCEDURE, SECOND UE INITIATES BEAM MEASUREMENT PROCEDURE)

Step 1: The beam failure can be detected by the first UE.
Step 2: When the beam failure is detected, the first UE may start a beam recovery procedure to transmit beam recovery signal to the first UE. If the beam recovery procedure is started, the first UE may start a beam recovery timer.
Step 3: After receiving the beam recovery signal, the second UE may start a beam measurement procedure to transmit N beam measurement configuration messages and M beam RSs to the first UE periodically. N and M are integer. The N and M can be determined based on first UE's capability.
Step 4: The second UE may receive the beam measurement result from first UE and may transmit beam recovery response message to the first UE. For the first UE, if the beam recovery signal is received and the beam recovery time is running, the first UE may consider/determine that the beam recovery procedure is complete successfully and may stop the beam recovery timer. If the beam recovery time expires, the first UE may consider/determine that the beam recovery procedure is failure and may consider/determine that the RLF is detected.

### EXAMPLE 5 (FIRST UE DETECTS BEAM FAILURE, SECOND UE INITIATES BEAM MEASUREMENT PROCEDURE, SECOND UE INITIATES RECOVERY PROCEDURE)

Step 1: The beam failure can be detected by the first UE.
Step 2: When the beam failure is detected, the first UE may transmit a beam failure indication to the second UE.
Step 3: After receiving the beam failure indication, the second UE may start a beam recovery procedure to transmit beam recovery signal to the first UE. If the beam recovery procedure is started, the second UE may start a beam recovery timer. The second UE may start a beam measurement procedure to transmit N beam measurement configuration messages and M beam RSs to fisrt UE periodically. N and M are integer. The N and M can be determined based on second UE's capability.
Step 4: The second UE may receive the beam measurement result and the beam recovery response message from the first UE. If the beam recovery response message is received and the beam recovery time is running, the second UE may consider/determine that the beam recovery procedure is complete successfully and stop the beam recovery timer. If the beam recovery time expires, the second UE may consider/determine the beam recovery procedure is failure and may consider/determine that the RLF is detected.

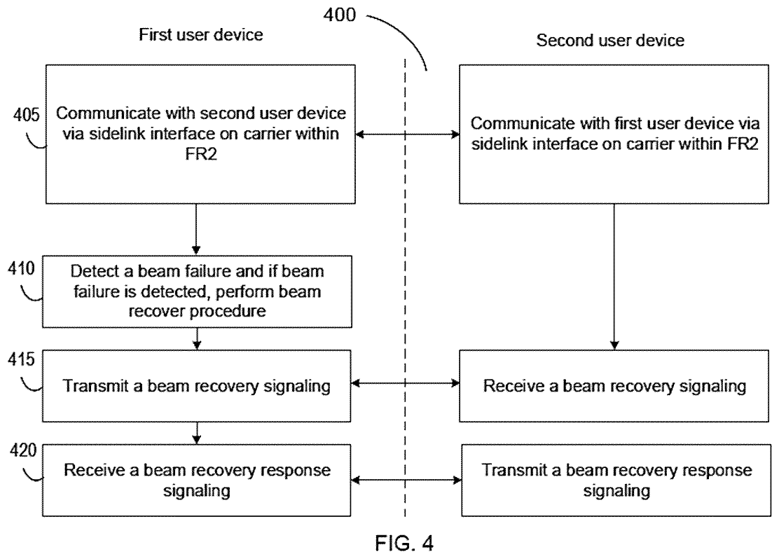

FIG. 5 illustrates a flow diagram of a method 500 for device-to-device communications on Frequency Range 2 (FR2). The method 500 may be implemented using any one or more of the components and devices detailed herein in conjunction with FIGS. 1-2. In overview, the method 500 may be performed by a wireless communication device, in some embodiments. Additional, fewer, or different operations may be performed in the method 500 depending on the embodiment. At least one aspect of the operations is directed to a system, method, apparatus, or a computer-readable medium.

Some arrangements of the present disclosure relate to systems, methods, apparatuses, and non-transitory computer-readable media relating to communicating, by a first wireless communication device with a second wireless communication device, via a sidelink interface. The first wireless communication device may send at least one of beam measurement configuration or beam Reference Signal (RS) to the second wireless communication device via the sidelink interface. The first wireless communication device may receive beam measurement result from the second wireless communication device via the sidelink interface.

In some arrangements, sending the beam measurement configuration may comprise starting a beam measurement procedure. The beam measurement procedure can be started in response to at least one of: a beam measurement timer expiry; determining that the first wireless communication device is to establish a unicast link; generating a Direct Communication Request (DCR) message; generating a discovery message; generating a sidelink Signaling Radio Bearer (SRB) message; or detecting a beam failure. The first wireless communication device may perform at least one of following in response to starting the beam measurement procedure: starting a beam measurement timer; starting a beam configuration transmission timer; or transmitting the beam measurement configuration. In response to determining that the beam configuration transmission timer has expired, the first wireless communication device may transmit the beam measurement configuration.

In some arrangements, the first wireless communication device may re-start the beam configuration transmission timer. In response to transmitting a first beam measurement configuration, the first wireless communication device may transmit a second beam measurement configuration. In response to determining that a number of beam measurement configuration transmission reaching a maximum number of beam measurement configuration transmission, performing at least one of following: the first wireless communication device may stop the beam measurement procedure, or the first wireless communication device may stop the beam measurement transmission timer.

In some arrangements, the beam measurement configuration may comprise at least one of: a beam configuration transmission timer; a beam measurement timer; a maximum number of beam measurement configuration transmission; beam recovery timer; a beam failure detection timer; the maximum beam failure indication number; a latency bound of the beam measurement result; a latency bound of the beam measurement configuration; a latency bound of the beam recovery signal; a latency bound of the beam recovery response signal; a maximum beam recovery signal transmission number; an indication indicating whether the beam RS is present; an indication indicating whether the second wireless communication device receiving the beam measurement configuration is to measure the beam RS; an indication indicating whether the second wireless communication device receiving the beam measurement configuration is to report the beam measurement result to the first wireless communication device; resource configuration for the beam RS; an identifier (ID) of the beam measurement configuration; an ID of the candidate beam; a measurement request indicating whether the second wireless communication device is to report the beam measurement result; beam measurement report configuration for the beam measurement result; or a beam index. The beam measurement configuration may comprise beam measurement report configuration. The beam measurement report configuration may comprise at least one of: a beam RS measurement threshold; or a period for reporting the measurement result.

In some arrangements, the beam measurement configuration may comprise beam RS resource configuration for the beam RS. The beam RS resource configuration for the beam RS may comprise at least one of: a beam index, a frequency resource location for the beam RS; a time resource location for the beam RS; a period for a resource for the beam RS; a resource type (e.g. RSRP reference signal, CSI reference signal, SL-MIB, or SSB) for the resource for the beam RS; a slot index for a slot for the beam RS; a resource pool identifier (ID) for the beam RS; or an ID of the beam RS. The beam measurement configuration can be contained in at least one of a System Information Block (SIB), a Radio Resource Control (RRC) signaling, a Media Access Control (MAC) Control Element (CE), a Sidelink Control Signaling (SCI), or a resource pool configuration. The beam measurement configuration can be received from a network.

Some arrangements of the present disclosure relate to systems, methods, apparatuses, and non-transitory computer-readable media relating to communicating, by a second wireless communication device with a first wireless communication device, via a sidelink interface. The second wireless communication device may receive at least one of beam measurement configuration or beam Reference Signal (RS) from the first wireless communication device via the sidelink interface. The second wireless communication device may measure the beam RS using the beam measurement configuration. The second wireless communication device may send beam measurement result to the first wireless communication device via the sidelink interface. The beam measurement configuration may comprise at least one of: a beam RS measurement threshold; a measurement request indicating whether the second wireless communication device is to report the beam measurement result; a latency bound of the beam measurement result; an indication indicating that the beam RS is present; an indication indicating that the second wireless communication device receiving the beam measurement configuration is to measure the beam RS; or an indication indicating that the second wireless communication device receiving the beam measurement configuration is to report the beam measurement result to the first wireless communication device.

In some arrangements, the second wireless communication device may send the beam measurement result in response to at least one of: determining that the beam measurement result is lower than a beam RS measurement threshold; determining beam failure of a beam in the sidelink interface; determining that the beam measurement result is to be sent according to periodicity; receiving a first message from the first wireless communication device, the first message comprising at least one of a Sidelink-Signaling Radio Bearer (SL-SRB) message, a Direct Communication Request (DCR) message, or a DCR response message. The beam measurement result may comprise at least one of: a measurement value of the beam RS; a recommended beam to be used for communication; a preferred beam to be used for communication; a non-preferred beam for communication; a candidate beam to be used for communication; an identifier (ID) of the beam measurement configuration; a slot index for a slot for the beam RS; a slot number for the slot for the beam RS; an ID of the beam RS; a beam index; an ID of a candidate beam RS, the candidate beam RS being recommended by the second wireless communication; an ID of a beam RS of a plurality of beam RSs that has a best measured value; or a slot index for a slot for the beam RS.

In some arrangements, the measurement value is at least one of RSRP value, a CSI value, or a measurement value higher than the beam RS measurement threshold. The recommended beam, the preferred beam, the non-preferred beam, or the candidate beam can be identified by at least one of: the ID of the beam measurement configuration; the ID of the beam RS; or the beam index.

Some arrangements of the present disclosure relate to systems, methods, apparatuses, and non-transitory computer-readable media relating to communicating, by a first wireless communication device with a second wireless communication device, via a sidelink interface. The first wireless communication device may determine a beam failure on the sidelink interface. In response to determining the beam failure, the first wireless communication device may perform at least one of: starting a beam recovery procedure; sending a beam indication signal indicating beam failure is detected; sending a beam measurement configuration; starting a beam measurement sweeping procedure; triggering a resource re-selection; or triggering a resource pool re-selection. The beam recovery procedure may include at least one of: sending, by the first wireless communication device to the second communication device via the sidelink interface, a beam recovery signal; starting a beam recovery timer; or receiving a beam recovery response signal is received from the second wireless communication device. The first wireless communication device may determine the beam failure in response to at least one of: determining that a number of beam failure indication from a physical layer reaches a maximum beam failure indication number; determining that the number of beam failure indication from the physical layer exceeds the maximum beam failure indication number; receiving a beam recovery signaling; determining that a number of consecutive absent Physical Sidelink Feedback Channel (PSFCH) reaches a threshold; to receiving an indication from a sidelink RLC entity indicating that a maximum number of retransmissions for a specific destination has been reached; determining that T400 for a specific destination has expired; receiving an indication from MAC entity that a maximum number of consecutive HARQ DTX for the specific destination has been reached; receiving an integrity check failure indication from sidelink PDCP entity for a specific destination; or receiving a beam indication signal indicating beam failure is detected.

In some arrangements, in response to detecting the beam failure, sending, by the first wireless communication device to a network, at least one of: an indication that the beam failure is detected; or a destination layer 2 identifier (ID) of a beam on which the beam failure is detected. The first wireless communication device may determine the beam recovery procedure has failed in response to at least one of: a number of beam recovery signal transmission reach the maximum beam recovery signal transmission number; the beam measurement result is lower than a beam RS measurement threshold; the first wireless communication device does not receive the beam recovery response signal from the second wireless communication device; or beam recovery timer expiry. The first wireless communication device may determine the beam recovery procedure is complete or successful in response to at least one of: the beam measurement result is higher than a beam RS measurement threshold; the beam failure detection timer started after receiving the beam failure indication from physical layer expiry; receiving the beam recovery response signal from the second wireless communication device; receiving the beam recovery response signal from the second wireless communication device and beam recovery timer is running; the sidelink BWP is re-configured; the sidelink resource pool is re-configured; or the beam measurement configuration is re-configured. The beam recovery signal may comprise at least one of beam measurement configuration, beam measurement result, oran indication on beam failure is detect. The beam recovery response signal may comprise at least one of beam measurement result, HARQ feedback, new sidelink transmission identified by a sidelink control information (SCI). In response to determining that a beam recovery procedure has failed, the first wireless communication device may determine that radio link failure (RLF) is detected.

Some arrangements of the present disclosure relate to systems, methods, apparatuses, and non-transitory computer-readable media relating to communicating, by a second wireless communication device with a first wireless communication device, via a sidelink interface. The second wireless communication device may receive a beam recovery signal from the first wireless communication device via the sidelink interface. The second wireless communication device may send beam recovery response signal to the first wireless communication device via the sidelink interface. The second wireless communication device may determine a beam failure on the sidelink interface. The second wireless communication device may send a beam failure indication signal to the first wireless communication device. The first wireless communication device may perform a beam recovery procedure in response to receiving the beam failure indication signal. The beam failure indication signal may comprise at least one of: beam measurement result; or an indication that the beam failure is detected.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
communicating, by a first wireless communication device with a second wireless communication device, via a sidelink interface;
sending, by the first wireless communication device to the second wireless communication device via the sidelink interface, at least one of beam measurement configuration or beam Reference Signal (RS); and
receiving, by the first wireless communication device from the second wireless communication device via the sidelink interface, beam measurement result.

2. The wireless communication method of claim 1, wherein sending the beam measurement configuration comprises starting a beam measurement procedure.

3. The wireless communication method of claim 2, wherein the beam measurement procedure is started in response to at least one of:
a beam measurement timer expiry;
determining that the first wireless communication device is to establish a unicast link;
generating a Direct Communication Request (DCR) message;
generating a discovery message;
generating a sidelink Signaling Radio Bearer (SRB) message; or
detecting a beam failure.

4. The wireless communication method of claim 2, wherein the first wireless communication device performs at least one of following in response to starting the beam measurement procedure:
starting a beam measurement timer;
starting a beam configuration transmission timer; or
transmitting the beam measurement configuration.

5. The wireless communication method of claim 4, comprising in response to determining that the beam configuration transmission timer has expired, transmitting, by the first wireless communication device, the beam measurement configuration.

6. The wireless communication method of claim 5, comprising re-starting, by the first wireless communication device, the beam configuration transmission timer.

7. The wireless communication method of claim 4, comprising
in response to transmitting a first beam measurement configuration, transmitting, by the first wireless communication device, a second beam measurement configuration.

8. The wireless communication method of claim 4, comprising in response to determining that a number of beam measurement configuration transmission reaches a maximum number of beam measurement configuration transmission, performing at least one of following: stopping, by the first wireless communication device, the beam measurement procedure, or stopping, by the first wireless communication device, the beam measurement transmission timer.

9. The wireless communication method of claim 1, wherein the beam measurement configuration comprises at least one of:
a beam configuration transmission timer;
a beam measurement timer;
maximum number of beam measurement configuration transmission;
beam recovery timer;
a beam failure detection timer;
the maximum beam failure indication number;
a latency bound of the beam measurement result;
a latency bound of the beam measurement configuration;
a latency bound of the beam recovery signal;
a latency bound of the beam recovery response signal;
a maximum beam recovery signal transmission number;
an indication indicating whether the beam RS is present;
an indication indicating whether the second wireless communication device receiving the beam measurement configuration is to measure the beam RS;
an indication indicating whether the second wireless communication device receiving the beam measurement configuration is to report the beam measurement result to the first wireless communication device;
resource configuration for the beam RS;
an identifier (ID) of the beam measurement configuration;
an ID of the candidate beam;
a measurement request indicating whether the second wireless communication device is to report the beam measurement result;
beam measurement report configuration for the beam measurement result; or a beam index.

10. The wireless communication method of claim 2, wherein
the beam measurement configuration comprises beam measurement report configuration; and
the beam measurement report configuration comprises at least one of:
a beam RS measurement threshold; or
a period for reporting the measurement result.

11. The wireless communication method of claim 1, wherein
the beam measurement configuration comprises beam RS resource configuration for the beam RS; and
the beam RS resource configuration for the beam RS comprises at least one of:
a beam index
a frequency resource location for the beam RS;
a time resource location for the beam RS;
a period for a resource for the beam RS;
a resource type for the resource for the beam RS;
a slot index for a slot for the beam RS;
a resource pool identifier (ID) for the beam RS; or
an ID of the beam RS.

12. The wireless communication method of claim 1, wherein the beam measurement configuration is contained in at least one of a System Information Block (SIB), a Radio Resource Control (RRC) signaling, a Media Access Control (MAC) Control Element (CE), a Sidelink Control Signaling (SCI), or a resource pool configuration.

13. The wireless communication method of claim 1, wherein the beam measurement configuration is received from a network.

14. A first wireless communication device, comprising:
at least one processor configured to:
communicate, via a transceiver with a second wireless communication device, via a sidelink interface;
send, via the transceiver to the second wireless communication device via the sidelink interface, at least one of beam measurement configuration or beam Reference Signal (RS); and
receive, via the transceiver from the second wireless communication device via the sidelink interface, beam measurement result.

15. A second wireless communication device, comprising:
at least one processor configured to:
communicate, via a transceiver with a first wireless communication device, via a sidelink interface;
receive, via the transceiver from the first wireless communication device via the sidelink interface, at least one of beam measurement configuration or beam Reference Signal (RS);
measure the beam RS using the beam measurement configuration; and
send, via the transceiver to the first wireless communication device via the sidelink interface, beam measurement result.

16. A wireless communication method, comprising:
communicating, by a second wireless communication device with a first wireless communication device, via a sidelink interface;
receiving, by the second wireless communication device from the first wireless communication device via the sidelink interface, at least one of beam measurement configuration or beam Reference Signal (RS);
measuring, by the second wireless communication device, the beam RS using the beam measurement configuration; and
sending, by the second wireless communication device to the first wireless communication device via the sidelink interface, beam measurement result.

17. The wireless communication method of claim 16, wherein the beam measurement configuration comprises at least one of:
a beam RS measurement threshold;
a measurement request indicating whether the second wireless communication device is to report the beam measurement result;
a latency bound of the beam measurement result;
an indication indicating that the beam RS is present;
an indication indicating that the second wireless communication device receiving the beam measurement configuration is to measure the beam RS; or
an indication indicating that the second wireless communication device receiving the beam measurement configuration is to report the beam measurement result to the first wireless communication device.

18. The wireless communication method of claim 16, wherein the second wireless communication device sends the beam measurement result in response to at least one of:
determining that the beam measurement result is lower than a beam RS measurement threshold;
determining beam failure of a beam in the sidelink interface;
determining that the beam measurement result is to be sent according to periodicity;
receiving a first message from the first wireless communication device, the first message comprising at least one of a Sidelink-Signaling Radio Bearer (SL-SRB) message, a Direct Communication Request (DCR) message, or a DCR response message, or a discovery message.

19. The wireless communication method of claim 16, wherein the beam measurement result comprises at least one of:
a measurement value of the beam RS;
a recommended beam to be used for communication;
a preferred beam to be used for communication;
a non-preferred beam for communication;
a candidate beam to be used for communication;
an identifier (ID) of the beam measurement configuration;
a slot index for a slot for the beam RS;
a slot number for the slot for the beam RS;
an ID of the beam RS;
a beam index;
an ID of a candidate beam RS, the candidate beam RS being recommended by the second wireless communication;
an ID of a beam RS of a plurality of beam RSs that has a best measured value; or
a slot index for a slot for the beam RS.

20. The wireless communication method of claim 19, wherein the measurement value is at least one of following:
RS received power (RSRP) value;
Channel state information (CSI) value; or
a measurement value higher than the beam RS measurement threshold.
